(19) United States
(12) Patent Application Publication
(10) Pub. No.: US 2026/0323103 A1
(43) Pub. Date: Oct. 15, 2026

(54) DYNAMICALLY CONTROLLED MULTIPLEXING OF STREAMED CONTENT

(71) Applicant: eFuse, Inc., Columbus, OH (US)

(72) Inventors: Najum A. Wani, Grove City, OH (US); Matthew Jeffrey Benson, Chillicothe, OH (US)

(73) Assignee: eFuse, Inc., Columbus, OH (US)

(21) Appl. No.: 19/174,901

(22) Filed: Apr. 9, 2025

(51) Int. Cl. H04N 21/236; H04L 65/611; H04N 21/2187; H04N 21/81

(52) U.S. Cl. CPC H04N 21/23614; H04L 65/611; H04N 21/2187; H04N 21/812

(57) ABSTRACT

Systems and methods are described to enable a content creator to influence and/or control the type of third-party data that is multiplexed within a livestream. Various embodiments provide for the resulting livestream to be transmitted directly to viewers or to a service provide that may insert additional third-party data into the livestream.

### TECHNICAL FIELD

The present disclosure relates generally to various embodiments of dynamically controlled systems and methods of multiplexing streaming content with other types of third-party data. More particularly, the present disclosure relates to embodiments of a multiplexing architecture in which content creators have influence or control of what types of third-party data, such as advertisements, media or other types of data known to one of skill in the art, are multiplexed within a livestream being transmitted across a network to viewers. Furthermore, in certain embodiments, a content creator may also influence or control the manner in which this third-party data, such as size and location, is multiplexed within a livestream.

### BACKGROUND

The influence and profitability of livestreaming content over a network to viewers is well understood by one of skill in the art. Technologies surrounding livestreaming enable a variety of different types of content providers to transmit content, in real time, to a larger number of viewers. For example, athletic events, eGaming events, educational seminars, television and movie media content and many other types of content may be viewed in real time by remote viewers across different service providers and network connections.

Service providers have developed business models for livestreaming that have enabled monetization of this content and resulted in significant revenue for the service provider as well as the content provider. Companies such as YouTube, Twitch, Kick and other similar service providers known to one of skill in the art have leveraged live streaming of content to generate significant revenue that impacts their businesses. In one example, a service provider is able to multiplex third-party data, such as advertisements, into a live stream to generate this revenue. The service providers implement algorithms that align this third-party data to particular viewers of the content to more effectively tailor advertisements (or realize other goals) to specific viewers than mass advertising/marketing employed by traditional media companies. These analyses and processes occur on the service provider platforms, which results in content providers oftentimes having minimal control as to which third-party data is multiplexed within its content being livestreamed.

FIG. 1 illustrates one prior art architectural example of how content and third-party data is combined at a streaming platform and subsequently transmitted to viewers. As shown, content provider 102 provides streams/content 120 to a streaming platform 104. As previously mentioned, a variety of different types of content may be live streamed to viewers across this platform. The streaming platform 104 may be implemented using different structural devices including servers, computers and other computing devices that enable the functions necessary to multiplex and livestream content on a network. Thereafter, the content and third-party data 130 is provided to the viewers.

The streaming platform 104 also interfaces with an ad server 106 that provides third-party data, such as advertisements, via a platform-controlled advertisement connection 125. One skilled in the art will recognize that server 106 is not limited to just advertisements but may also provide other types of third-party data to be combined within the livestream. In most cases, revenue generated by the livestream is divided between the streaming service provider and the content provider. However, this architecture and business arrangement results in the content provider having minimal or zero control over what type of third-party data is added to the content, how the data is combined with the content, and other types of control that may be important to different content providers.

What is needed are systems, devices and methods that increase the ability of content providers to influence what types of third-party data are multiplexed within their content and the manner in which that data is combined with the content.

### BRIEF DESCRIPTION OF DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale.

FIG. 1 shows a prior art system in which the multiplexing of content and third-party data is controlled by a streaming platform.

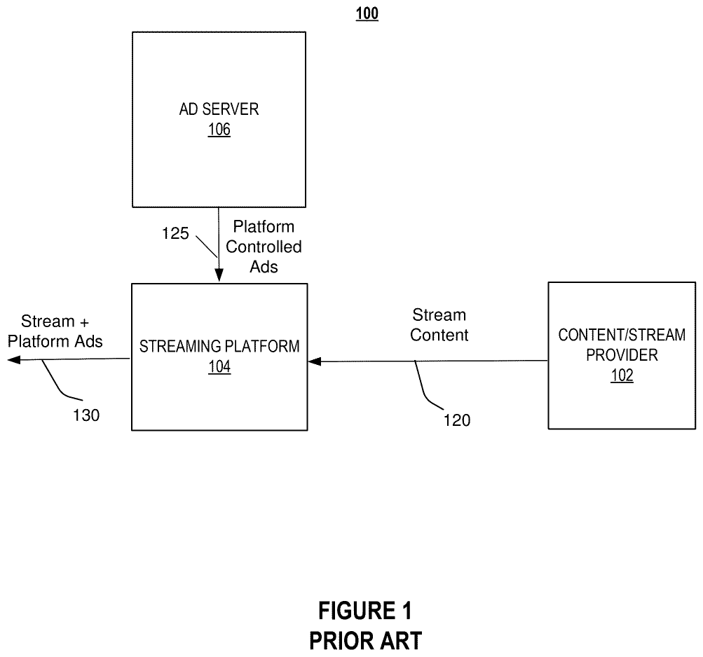

FIG. 2 shows a first system for multiplexing content and third-party data into a livestream in which a content creator has, at a minimum, influence in the type of third-party data that is multiplexed within the livestream according to various embodiments of the invention.

FIG. 3 shows a second system for multiplexing content and third-party data into a livestream in which a content creator has, at a minimum, influence in the type of third-party data that is multiplexed within the livestream according to various embodiments of the invention.

FIG. 4 shows a first exemplary content/stream provider server that multiplexes advertisements with content within a livestream in a manner that is either controlled or influenced by a content provider according to various embodiments of the invention.

FIG. 5 shows an exemplary of an ad server that enables multiplexing of advertisements with content within a livestream in a manner that is either controlled or influenced by a content provider according to various embodiments of the invention.

FIG. 6 shows a second exemplary content/stream provider server that multiplexes advertisements with content within a livestream in a manner that is either controlled or influenced by a content provider according to various embodiments of the invention.

FIG. 7 is a flowchart that illustrates a method for multiplexing content with advertisements within a livestream in a manner that is either controlled or influenced by a content provider according to various embodiments of the invention.

FIG. 8 illustrate examples of computing systems on which software is stored and/or executed to multiplex content with advertisements within a livestream in a manner that is either controlled or influenced by a content provider according to various embodiments of the invention.

### DETAILED DESCRIPTION

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in a variety of structures facilitating the multiplexing of content with third-party data that enables the content provider to control and/or influence this process.

Furthermore, connectivity between components or systems within the figures are not intended to be limited to direct connections. Rather, connections between these components may be modified, or otherwise changed by intermediary components. Also, components may be integrated together or be discrete within the streaming system.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or functionals may be optional; (2) components or functions may not be limited to the specific description set forth herein; (3) certain components or functions may be assembled/combined differently across different platforms; and (4) certain functions may be performed concurrently or in sequence.

Furthermore, it shall be noted that many embodiments described herein are given in the context of the multiplexing content with third-party data, but one skilled in the art shall recognize that the teachings of the present disclosure may apply to other functions that combine content and third-party data.

In this document, “third-party data” refers to any content developed by an entity that is not the content provider or the streaming platform that is displayed within the livestream. Examples of third-party data include advertisements, media, notices and other content developed by a third-party. The term “streaming platform” refers to any computing structure that is controlled by a streaming service to combine third-party data within content generated by a content provider. The term “multiplexing” refers to the combination of a stream (such as a livestream) with third-party data (such as an advertisement) such that both the stream and third-party data are provided to a viewer.

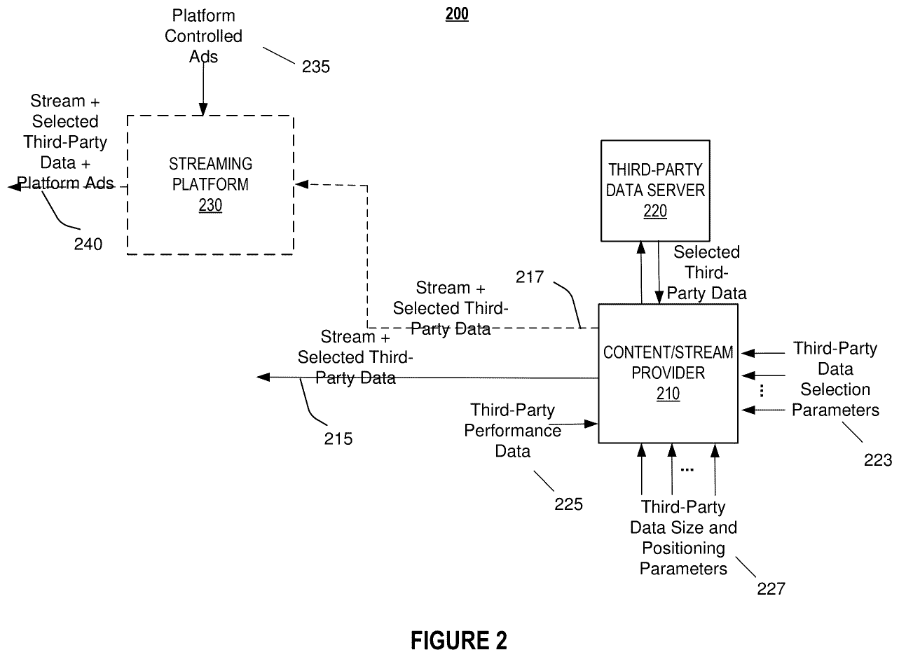

FIG. 2 is an architecture that allows content providers to influence what type and how third-party data is combined with content prior to transmission to viewers according to various embodiments of the invention. As shown, the functionality of the content/stream provider platform 210 is enhanced to allow multiplexing of third-party data within a stream independent of a streaming platform 230. In certain embodiments, the streaming platform 230 is not implemented in providing livestreams to viewers. In other embodiments, the streaming platform 230 is implemented after content is combined with third party data at the content/stream provider platform 210.

In certain embodiments, the content/stream provider platform 210 may interface with a third-part data server 220, an example of which is an ad server, from which third-party data such as advertisements are received. The platform 210 may also receive a plurality of input information that controls what type of third-party data is multiplexed with the content. In at least one embodiment, the content creator has control of these inputs. A plurality of third-party data selection parameters 223 allows a content creator to define metrics related to which type of third-party data is selected for combination with the content. The third-party data selection parameters may include, but are not limited to, methods for ad selection, dynamic resizing, or content integration such as AI based ad selection, programmatic APIs, or UI tools for streamers. Additionally, other parameters may include contextual triggers (gameplay recognition, chat engagement, voice commands) to further allow dynamic control of third-party data that is combined with streams. Additionally, other parameters may include contextual triggers (gameplay recognition, chat engagement, voice commands) to further allow dynamic control of third-party data that is combined with streams. For example, if the content creator would prefer certain types of ads not to be combined with the content, this preference may be provided to platform 210. Also, the plurality of third-party data selection parameters 223 may allow a content creator to specifically determine the third-party data or third-party data types to be combined with the content. One skilled in the art will recognize that a variety of different third-party data selection parameters may be implemented to further enhance the influence of a content generator in the selection of third-party data to be combined with content. Examples of these parameters include, but are not limited to, adult content/ads such as alcohol or smoking, geography-related content/ads, political-related content/ads, demographic data, psychographic data, content/stream provider data, stream data, chat data, etc.

The content/stream provider platform 210 may also receive a plurality of inputs relating to the third-party data size and positioning parameters 227. These parameters 227 allow a content provider to influence or define the size, location within an image, frame position within a stream and other related parameters. These parameters 227 allow the content provider not only to determine which third-party data/type of third-party data are to be used but also the manner in which the third-party data (e.g., ads, media, etc.) are presented to the viewer. In certain embodiments, the provider platform 210 may also receive third-party performance data 225 to provide feedback as to the effectiveness of the third-party data, such as an ad or characteristics of the viewer, so that a more dynamic selection process may occur within the boundaries defined by the content provider.

In certain embodiments, the content/stream provider platform 210 may also receive parameters about a streaming platform used to deliver the livestream to viewers to further enable dynamic selection and insertion of third-party data within the content stream. Accordingly, in at least one embodiment, the platform 210 is able to intelligently define third-party data, dynamically position third-party data, take into account the characteristics of the streaming platform while remaining within boundaries established by the content provider.

In certain embodiments, the content/stream provider 210 combines the stream and selected third-party data 215 into a live stream that is transmitted to viewers. In other embodiments, the stream and selected third-party data 217 are transmitted to a streaming platform 230 that may further modify the stream. For example, the streaming platform may insert addition platform-controlled ads 235 into the stream. Thereafter, the multiplexed stream, selected third-party data and platform ads 240 are transmitted to viewers. One skilled in the art will recognize that a variety of different structural and functional implementations may be realized in accordance with this figure, all of which are intended to fall within the scope of the claims.

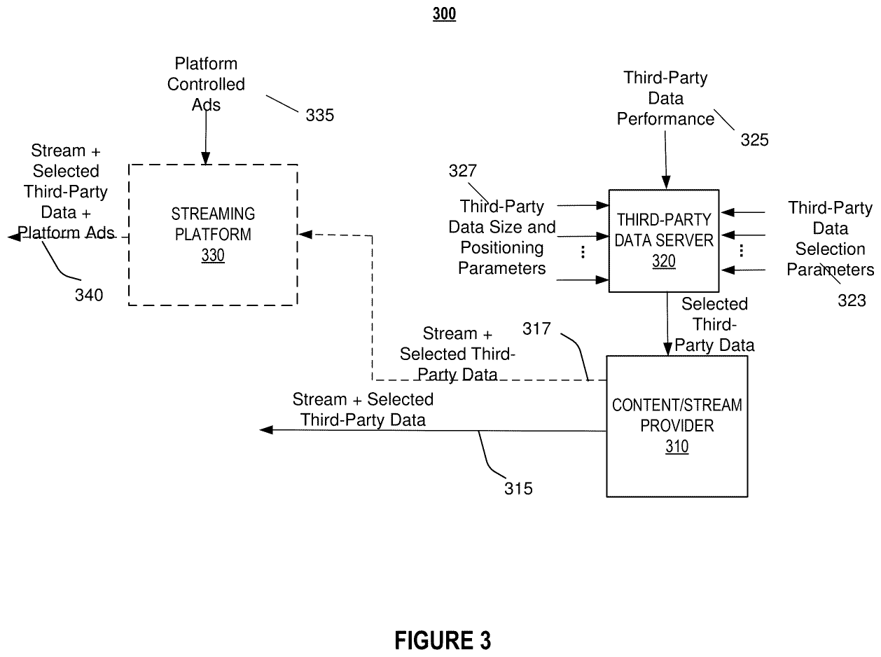

FIG. 3 is another architecture that allows content providers to influence what type and how third-party data is combined with content prior to transmission to viewers according to various embodiments of the invention. As shown, input parameters are provided to the third-party data server 320 instead of the content stream provider platform 310.

In these embodiments, the third-party data server 320 may be provided information relative to the content provider's parameters in controlling third-party data to be multiplexed with content for streaming. The third-party data server 320 may receive a plurality of input information that controls what type of third-party data is multiplexed with the content. In at least one embodiment, the content creator has control of these inputs. A plurality of third-party data selection parameters 323 allows a content creator to define metrics related to which type of third-party data is selected for combination with the content. The third-party data selection parameters may include, but are not limited to, methods for ad selection, dynamic resizing, or content integration such as AI based ad selection, programmatic APIs, or UI tools for streamers. Additionally, other parameters may include contextual triggers (gameplay recognition, chat engagement, voice commands) to further allow dynamic control of third-party data that is combined with streams. For example, if the content creator would prefer certain types of third-party data not to be combined with the content, this preference may be provided to the third-party data server 320. Also, the plurality of third-party data selection parameters 323 may allow a content creator to specifically determine the third-party data or third-party data types to be combined with the content. One skilled in the art will recognize that a variety of different ad selection parameters may be implemented to further enhance the influence of a content generator in the selection of third-party data to be combined with content. Examples of these parameters include, but are not limited to, adult content/ads such as alcohol or smoking, geography-related content/ads, political-related content/ads, demographic data, psychographic data, content/stream provider data, stream data, chat data, etc.

The third-party data server 320 may also receive a plurality of inputs relating to the third-party data size and positioning parameters 327. These parameters 327 allow a content provider to influence or define the size, location within an image, frame position within a stream and other related parameters. These parameters 327 allow the content provider not only to determine which third-party data/type of third-party data are to be used but also the manner in which the third-party data are presented to the viewer. In certain embodiments, the third-party data server 320 may also receive third-party performance data 325 to provide feedback as to the effectiveness of the third-party data or characteristics of the viewer so that a more dynamic selection process may occur within the boundaries defined by the content provider.

Based on these parameters, the third-party data server 320 selects third-party data, such as advertisements, that are transmitted to the content/stream provider platform 310. The platform 310 multiplexes this selected third-party data with content to generate a livestream. In certain embodiments, the content/stream provider 310 combines the stream and selected third-party data 315 into a livestream that is transmitted to viewers. In other embodiments, the stream and selected third-party data 317 are transmitted to a streaming platform 330 that may further modify the stream. For example, the streaming platform may insert addition platform-controlled ads 335 into the stream. Thereafter, the multiplexed stream, selected third-party data and platform ads 340 are transmitted to viewers. One skilled in the art will recognize that a variety of different structural and functional implementations may be realized in accordance with this figure, all of which are intended to fall within the scope of the claims.

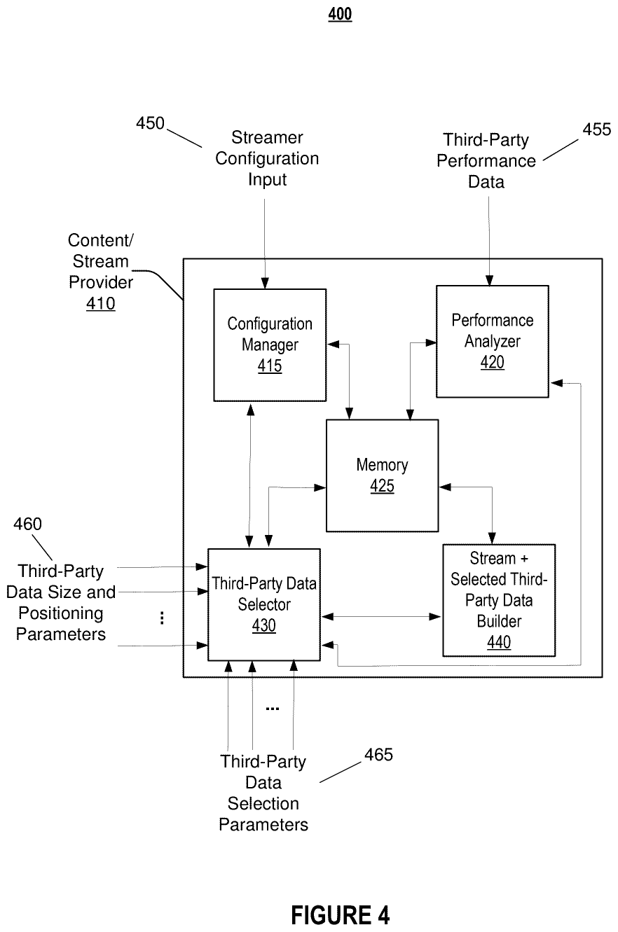

FIG. 4 illustrates a content/stream provider platform according to various embodiments of the invention. As previously discussed, the ability of a content provider to influence what type and how third-party data is multiplexed into a content stream may be provided on the content stream provider platform 410. The platform 410 may be realized using computing devices, such as a server and/or a computer, to allow a content creator's input on the selection of third-party data, such as advertisements. The platform 410 comprises a configuration manager 415 that has an interface on which streamer configuration data 450 may be provided. This configuration data may include parameters related to the content, the third-party data, the manner in which content and third-party data are combined, and other parameters understood by one skilled in the art. In certain embodiments, the configuration manager 450 defines functionality related to multiplexing of content with third-party data.

A third-party data selector 430 is coupled to the configuration manager 415, memory 425 and a plurality of inputs related to third-party data selection, size and positioning. As previously discussed, the third-party data selector 430 selects third-party data, such as advertisements based at least on part on parameters supplied by a content creator. In this example, a content provider may provide third-party data selection parameters 465 that relate to the type of third-party data available to be combined with content. The third-party data selection parameters may include, but are not limited to, methods for ad selection, dynamic resizing, or content integration such as AI based ad selection, programmatic APIs, or UI tools for streamers. Additionally, other parameters may include contextual triggers (gameplay recognition, chat engagement, voice commands) to further allow dynamic control of third-party data that is combined with streams. The content provider may also provide parameters such as the size and positioning of third-party data inserted within the content. In certain embodiments, the third-party data selector 430 may interface with a performance analyzer 420 that analyzes characteristics of viewers that are watching the livestreamed content as well as historical data that relates to the effectiveness of third-party data, such as ads or media, to one or more viewers. Using this additional data, the third-party data selector 430 is able to improve the third-party data selection based on both parameters from the content provider as well as analytics relating to the viewers and type of third-party data that are more effective.

A memory 425 is coupled to the configuration manager 415, the performance analyzer 420, and the third-party data selector 430 to store relevant information and data used in each of the devices. The memory 425 is also coupled to the stream and selected third-party data builder 440 that multiplexes and/or combines the content stream and the third-party data into a livestream signal that is transmitted to the viewers.

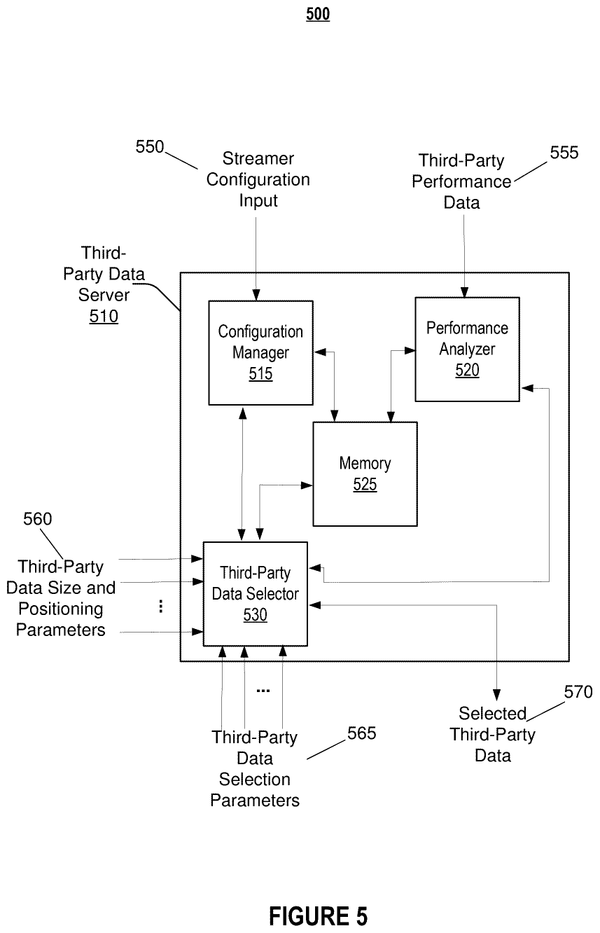

FIG. 5 illustrates an ad server 510 that incorporates at least some of the functionality used to select third-party data for combination with content according to various embodiments of the invention. As shown, the ad server 510 comprises a configuration manager 515, a performance analyzer 520, memory 525 and an ad selector 530. In this embodiment, third-party data such as advertisements are selected on the ad server 510 and subsequently transmitted for integration into a content stream by the content/stream provider platform 310.

The configuration manager 515 has an interface on which streamer configuration data 550 may be provided. This configuration data may include parameters related to the content, the third-party data, the manner in which content and third-party data are combined, and other parameters understood by one skilled in the art. In certain embodiments, the configuration manager 550 defines functionality related to multiplexing of content with third-party data.

A third-party data selector 530 is coupled to the configuration manager 515, memory 525 and a plurality of inputs related to third-party data selection, size and positioning. As previously discussed, the third-party data selector 530 selects third-party data, such as advertisements or media based at least in part on parameters supplied by a content creator. In this example, a content provider may provide third-party data selection parameters 565 that relate to the type of third-party data available to be combined with content. The third-party data selection parameters may include, but are not limited to, methods for ad selection, dynamic resizing, or content integration such as AI based ad selection, programmatic APIs, or UI tools for streamers. Additionally, other parameters may include contextual triggers (gameplay recognition, chat engagement, voice commands) to further allow dynamic control of third-party data that is combined with streams. The content provider may also provide parameters 560 such as the size and positioning of third-party data inserted within the content. In certain embodiments, the third-party data selector 530 may interface with a performance analyzer 520 that analyzes characteristics of viewers that are watching the livestreamed content as well as historical data that relates to the effectiveness of third-party data to one or more viewers. Using this additional data, the third-party data selector 530 is able to improve the third-party data selection based on both parameters from the content provider as well as analytics relating to the viewers and types of advertisements that are more effective.

Once third-party data, such as advertisements, are selected by the third-party data selector 530, this third-party data is sent to the content/stream provider platform 310 so that it may be combined with content into a livestream for transmission across a network to viewers. As with previously described embodiments, this example allows a content generator to influence and/or control the types, size and placement of third-party data within content.

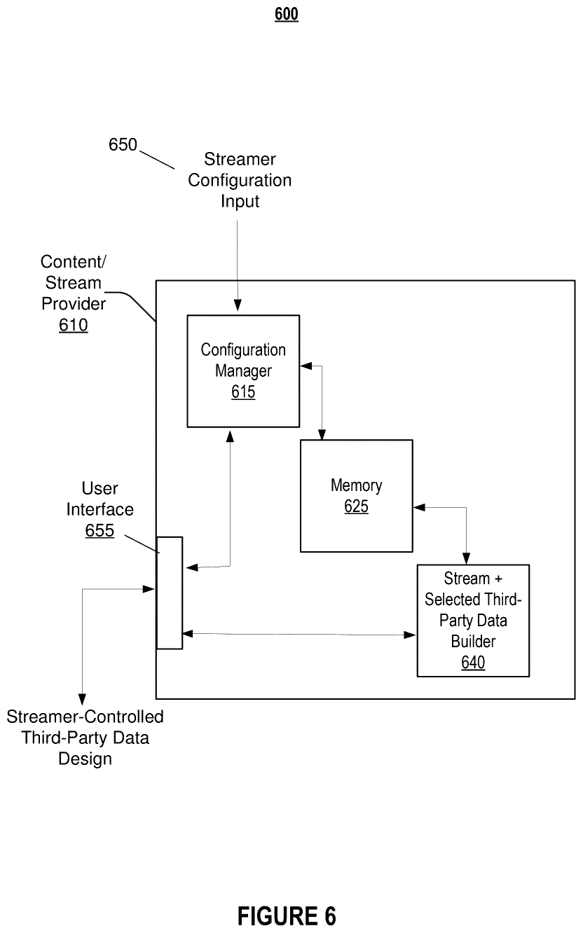

FIG. 6 illustrates a content/stream provider platform 610 that receives selected third-party data, such as advertisements, from the third-party data server 510 according to various embodiments of the invention. As shown, platform 610 comprises a configuration manager 615, a memory 625 and stream and selected third-party data builder 640. In this embodiment, platform 610 receives selected third-party data, such as advertisements, from the third-party data server 510.

Configuration manager 615 receives streamer configuration information 650 that is used to control the platform and the manner in which content and third-party data are combined. For example, streamer configuration information may define functionality related to specific processes related to multiplexing content and third-party data or other parameters known to one of skill in the art. The configuration manager 615 is coupled to memory 625 to enable storage of the configuration information and any data derived therefrom. In certain embodiments, the configuration manager 615 may also be coupled to a user interface 655 to allow exchange of configuration with external components or other users.

The memory 625 stores information and data from the configuration manager 615 and allows the stream and selected third-party data builder 640 to retrieve information. This information may include both content and third-party data that is to be multiplexed into a livestream signal. In certain embodiments, the stream and selected third-party data builder 640 receives pre-selected third-party data, such as advertisements, from interface 655 or other interfaces on the platform 610.

The stream and selected third-party data builder 640 multiplexes the preselected third-party data and content consistent with configuration data into a live stream that is subsequently transmitted to viewers. The result of this process is functionality that enables a content creator to have control and/or influence over the type, size and placement of third-party data into a livestream with content to be viewed by the viewers.

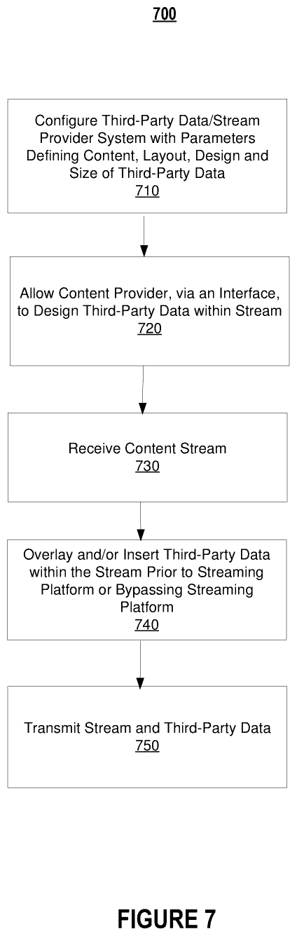

FIG. 7 is a flowchart 700 illustrating a process in which a content creator is provided with control and/or influence over the integration of third-party data, such as advertisements, with the content into a livestream according to various embodiments of the invention. This process defines functionality independent of structure.

In a first step, a third-party data/stream provider platform is configured with parameters defining content, layout, design and size of third-party data such as advertisements 710. At least some of these parameters may be provided by the content creator or derived from inputs from the content creator. In certain embodiments, an interface is provided that allows the content provider to provide third-party selection parameters at a content/stream provider platform or at an third-party data server 720.

In various embodiments, a content stream is received comprising content to be integrated within a livestream 730. Third-party data, such as advertisements, are overlayed, multiplexed or otherwise combined with the content consistent with the parameters provided by the content generator 740. In certain embodiments, this combination of third-party data and content into a livestream is performed prior to any manipulation by a service provider or used to enable bypassing the service provider in delivering the livestream to the viewers.

After a livestream is constructed consistent with content creator parameters, the livestream is transmitted 750 to viewers.

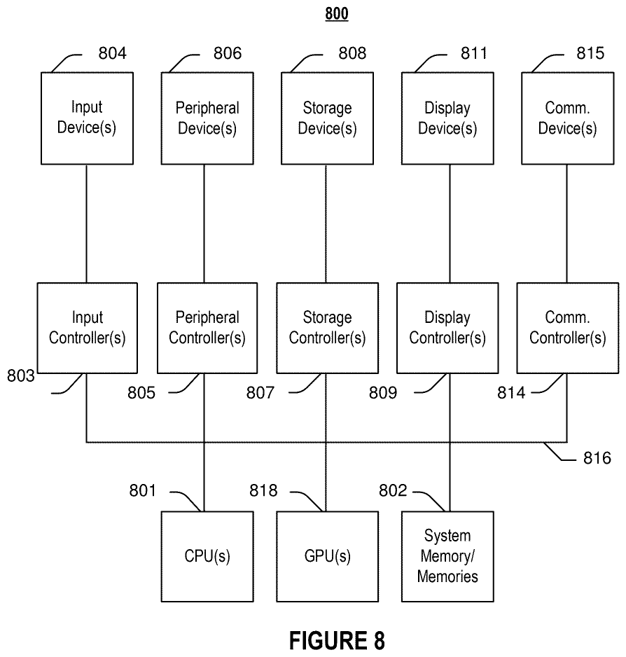

FIG. 8 depicts a simplified block diagram of a computing device/information handling system (or computing system) according to embodiments of the present disclosure. It will be understood that the functionalities shown for system 800 may operate to support various embodiments of a computing system—although it shall be understood that a computing system may be differently configured and include different components, including having fewer or more components as depicted in FIG. 8.

As illustrated in FIG. 8, the computing system 800 includes one or more central processing units (CPU) 801 that provide(s) computing resources and control(s) the computer. CPU 801 may be implemented with a microprocessor or the like and may also include one or more graphics processing units 818 and/or a floating-point coprocessor for mathematical computations. System 800 may also include a system memory 802.

A number of controllers and peripheral devices may also be provided, as shown in FIG. 8. An input controller 803 represents an interface to various input device(s) 804, such as a keyboard, mouse, touchscreen, and/or stylus. The computing system 800 may also include a storage controller 807 for interfacing with one or more storage devices 808 each of which includes a storage medium such as flash memory or disk memory or RAM/ROM memory, or an optical medium that might be used to record programs of instructions for operating systems, utilities, and applications, which may include embodiments of programs that implement various aspects of the present invention. Storage device(s) 808 may also be used to store processed data or data to be processed in accordance with the invention. The system 800 may also include a display controller 809 for providing an interface to a display device 811, which may be a cathode ray tube, a thin film transistor display, organic light-emitting diode, electroluminescent panel, plasma panel, or other type of display. The computing system 800 may also include one or more peripheral controllers or interfaces 805 for one or more peripherals. Example of peripheral may include one or more printers, scanners, input devices, output devices, sensors, and the like. A communications controller 814 may interface with one or more communication devices 815, which enables the system 800 to connect to remote devices through any of a variety of networks including the Internet, a cloud resource (e.g., an Ethernet cloud, a Fiber Channel over Ethernet/Data Center Bridging cloud, etc.), a local area network, a wide area network, a storage area network, or through any suitable electromagnetic carrier signals including infrared signals. A cloud or wireless controller may also be provided that interface with various cloud or wireless devices.

In the illustrated system, all major system components may connect to a bus 816, which may represent more than one physical bus. However, various system components may or may not be in physical proximity to one another. For example, input data and/or output data may be remotely transmitted from one physical location to another. In addition, programs that implement various aspects of the invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Aspects of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” or any other term subject to 35 USC § 112 terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A content streaming platform comprising:
a first interface coupled to a third-party data server, the first interface enables third-party data to be retrieved;
a plurality of third-party data selection parameter interfaces that receives a first set of parameters from a content provider that defines at least a portion of first set of characteristics used to select the third-party data to be multiplexed into a livestream;
a plurality of third-party data size and positioning parameter interfaces that receives a second set of parameters that defines at least a portion of a second set of characteristics used to size and position third-party data within the livestream; and
an output interface that transmits a livestream comprising multiplexed content with the third-party data to a plurality of viewers.

2. The content streaming platform of claim 1 wherein the third-party data comprises a plurality of advertisements.

3. The content streaming platform of claim 1 further comprising an third-party performance data interface on which information related to performance of third-party data is provided to the content streaming platform.

4. The content streaming platform of claim 3 wherein the third-party data is selected based at least in part on the third-party performance data.

5. The content stream platform of claim 4 wherein the third-party performance data comprises machine-learning based selection of third-party data.

6. The content streaming platform of claim 1 wherein the first set of parameters define at least one type of third-party data to be excluded from being multiplexed with the content.

7. The content streaming platform of claim 1 wherein the first set of parameters define at least one type of third-party data to be included in being multiplexed with the content.

8. The content streaming platform of claim 1 wherein the first set of parameters comprises at least one contextual trigger.

9. The content streaming platform of claim 1 wherein the livestream is transmitted to a service provider prior to reception by a viewer.

10. A method for multiplexing content with third-party data into a livestream, the method comprising:
configuring a computing device with parameters that define at least one of type, layout, design and size of third-party data to be multiplexed with content into livestream;
receiving a first set of characteristics from a content generator related to the parameters that limit at least one of the parameters in selecting the third-party data to be multiplexed with the content;
receiving a content stream;
selecting third-party data consistent with the parameters and the first set of characteristics;
multiplexing the third-party data with the content; and
transmitting the multiplexed third-party data and content to a plurality of viewers.

11. The method of claim 10 wherein the third-party data comprises a plurality of advertisements.

12. The method of claim 10 wherein the content generator directly interacts with a streaming platform to provide the first set of characteristics.

13. The method of claim 10 further comprising the step of receiving performance data to further enable a selection of the third-party data.

14. The method of claim 10 wherein the multiplexed third-party data and content within a livestream is transmitted to a service provider.

15. The method of claim 14 wherein the service provider inserts additional third-party data into the livestream.

16. The method of claim 10 wherein the parameters that define at least one of type, layout, design and size of third-party data is provided by the content creator.

17. A system for multiplexing third-party data and content into a livestream, the system comprising:
a processor; and
a non-transitory computer-readable medium comprising instructions that, when executed by the processor, cause steps to be performed, the steps comprising:
configuring a computing device with parameters that define at least one of type, layout, design and size of third-party data to be multiplexed with content into livestream;
receiving a first set of characteristics from a content generator related to the parameters that limit at least one of the parameters in selecting the third-party data to be multiplexed with the content;
receiving a content stream;
selecting third-party data consistent with the parameters and the first set of characteristics;
multiplexing the third-party data with the content; and
transmitting the third-party data and content to a plurality of viewers.

18. The system of claim 17 wherein the third-party data comprises a plurality of advertisements.

19. The system of claim 17 wherein the content generator directly interacts with a streaming platform to provide the first set of characteristics.

20. The system of claim 10 wherein the multiplexed third-party data and content within a livestream is transmitted to a service provider.
